(19) United States
(12) Patent Application Publication
(10) Pub. No.: US 2003/0139270 A1
(43) Pub. Date: Jul. 24, 2003

(54) Development roller of electro-photographic machine

(75) Inventors: Hee-Won Jung, Suwon-City (KR); Jong-Moon Eun, Suwon-City (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-City (KR)

(21) Appl. No.: 10/277,740

(22) Filed: Oct. 23, 2002

(30) Foreign Application Priority Data
Jan. 18, 2002 (KR) 2002-3122

(51) Int. Cl. B25F 5/02; F16C 13/00; B21K 1/02; B21D 53/00

(52) U.S. Cl. 492/56; 492/59; 29/895

(57) ABSTRACT

A development roller of an electric-photographic machine is manufactured by a method of mixing a base material of either NBR rubber or HYDRIN rubber, an electric conductive high-molecule-weight material to adjust an electric resistivity of the development roller, and peroxide as a cross-link agent cross-linking the base material and the electric conductive high-molecule-weight material in a three-dimensional structure, forming the development roller from a mixture of the base material, the electric conductive high-molecule-weight material, and peroxide, and irradiating the development roller with ultraviolet light to adjust a friction coefficient of a surface of the development roller. Accordingly, the development roller has characteristics of a low electric resistivity even with a single layer structure.

### CROSS-REFERENCE TO RELATED APPLICATIONS

This application claims the benefit of Korean Application No. 2002-312, filed Jan. 18, 2002, in the Korean Industrial Property Office, the disclosure of which is incorporated herein by reference.

### BACKGROUND OF THE INVENTION

1. Field of the Invention

The present invention relates to an electric-photographic machine, such as a laser printer, a photocopier or a facsimile machine, and more particularly, to a development roller of an electric-photographic machine having a single layer made of a lower cost rubber, such as NBR, and formed coaxially on and around a shaft to have a characteristic of a low electric resistivity.

2. Description of the Related Art

Generally, in an electric-photographic machine such as a laser printer, a photocopier, or a facsimile machine, a latent electrostatic image is formed on a surface of a photoconductive drum, and a charged toner is supplied onto the surface of the photoconductive drum. Then the latent electrostatic image formed on the surface of the photoconductive drum is developed with the charged toner to a visible toner image. The developed visible toner image is then transferred to a printing material, such as a sheet of paper, and then fused on to the printing material. Thus, the toner image is recorded on the printing material.

The toner for developing the latent electrostatic image formed on the surface of the photoconductive drum is typically transferred from a housing to an area adjacent to the photoconductive drum by a development roller. An example of a development apparatus including the development roller is shown in FIG. 1.

Referring to FIG. 1, the development apparatus includes the development roller 2, an agitator 4, a housing 3, toner 5, and an electricity unit 7. The development roller 2 is disposed parallel to and adjacent to the photoconductive drum 1 and carries the toner 5 that sticks to a surface of the development roller 2 by an electrostatic force generated in a development area between the development roller 2 and the photoconductive drum 1 which are spaced-apart by a distance “d”. The agitator 4 stirs the toner 5 contained in the housing 3 so that the toner 5 is transported to the development roller 2. The development roller 2 and the agitator 4 are rotatably disposed in the housing 3, and the housing 3 contains the toner 5 so as not to flow out. The toner 5 is transferred to the development area by the development roller 2 and develops the latent electrostatic image formed on the surface of the photoconductive drum 1 to the visible toner image. The electricity unit 7 provides a predetermined voltage to the photoconductive drum 1 and the development roller 2.

Here, in order to uniformly maintain a quality of the image transferred on the printing material, an amount of the toner transferred to the photoconductive drum 1 by the development roller 2 should be constant. Accordingly, an electric field that is generated by the voltage provided from the electricity unit 7 should be maintained constant regardless of variable ambient conditions. If an electric resistivity of the development roller 2 is low, a change of the electric field of the development roller 2 according to the ambient conditions is small. But in this case, there is a defect that a grayscale of an image is poor because a fringing portion of the electric field of the development roller 2 is weak.

So far, to satisfy the above condition required in the development roller as described above, various development rollers have been proposed and then used.

For one example, to satisfy the above condition as described above, another development roller has been proposed to have an inner elastic layer 2 with a low electric resistivity and an outer layer 2a covering the inner layer 2 and having a high electric resistivity.

In this case, the inner layer 2 is made of an elastic semi-conductive material which an electro-conductive material is added to and dispersed into, or made of sponge of an electro-conductive material. The outer layer 2a is provided by coating a surface of the inner layer 2 with an insulating material or by inserting a hollow cylinder made of the insulating material into the inner layer 2.

As another example, the development roller is provided with a single layer that is formed by a base material to which a conductivity-imparting agent is added to satisfy the electric resistivity required in the development roller. In this case, the electric resistivity is preferably below 10⁶Ω. For example, to adjust the electric resistivity of the development roller, the development roller may be made of urethane rubber to which a conductivity-imparting agent is added or EDPM rubber to which an ionic conductivity-imparting agent, such as conductive carbon blacks or epichlorohydrin, is added.

As yet another example, the development roller is made of a material having a low electric resistivity and silicone rubber having an elasticity satisfying the above condition.

But, the conventional development rollers have the following problems.

First, in a case of the development roller with double layers, the development roller needs two extrusion mold processes of making the inner layer and the outer layer. Accordingly, a manufacturing cost of the development roller is high because of a lot of man-hours and a large defective proportion. Particularly, when the inner layer is made of a foamed rubber, adhesion between the outer layer and the inner layer may be poor, or fine holes as a defect may be easily formed in a surface of the outer layer.

Second, in another case of adjusting the electric resistivity of the development roller by adding conductive carbon blacks to a semi-conductive rubber, there is a problem that the electric resistivity of the development roller is not uniform because the conductive carbon blacks are not dispersed uniformly in the development roller. If the conductive carbon blacks are used over 10 phr (parts by weight per hundred rubber) for maintaining the electric resistivity of the development roller below 10⁶Ω, the development roller becomes very hard and so loses an elastic characteristic as rubber. Accordingly, because the toner adsorbed on the surface of the development roller cannot be regulated in a predetermined amount by a regulating member, which is disposed in contact with the surface of the development roller, a thickness of a layer of the adsorbed toner is not uniform. Thus, an image defect, such as a change of an image concentration, occurs. Also, because the toner is received with an excessive physical stress by the development roller, the toner is degraded, and thus durability of the toner is decreased. Because an electric charging characteristic of particles of the toner is decreased by the conductive carbon blacks added to the development roller, problems, such as a short supply of the toner or a missing image, occur.

Third, in another case of the development roller made of the semi-conductive rubber to which all antistatic agent or an electric conductive agent except the carbon blacks is added, when the development roller is not used for a long period of time, problems, such as migration, a volatilization of the low molecular electric conductive agent or a secular change of the electric resistivity of the development roller may occur. The migration described above means that particles of the electric conductive agent added to the development roller are moved to the surface of the development roller.

Fourth, in another case of the development roller made of urethane rubber, since the urethane rubber is expensive, the manufacturing cost of the development roller is high. Also, if a low molecular polyol or hardening agent remains on the surface of the development roller, a filming phenomenon, in which the toner is deposited in the form of a film on the surface of the development roller, may occur.

Finally, in another case of the development roller made of silicone rubber having the low electric resistivity, the migration, in which non cross-linked low-molecular-weight materials of the silicone rubber are migrated to the surface of the development roller, may occur. Accordingly, when the surface of the development roller is continuously in contact with the toner for an extended period of time, there is a problem that the toner cakes thereon.

### SUMMARY OF THE INVENTION

Therefore, it is an object of the present invention to provide a development roller of an electric-photographic machine which is made of a rubber material and an electric conductive high-molecule-weight material, which are cross-linked simultaneously by a peroxide cross-linking instead of a conventional sulfur cross-linking, to have a three-dimensional reticular structure of the development roller. Thus, this development roller has an improved abrasive quality and minimized migration that a low-molecule weight material is moved to a surface of the development roller. Also, a surface roughness of the development roller is easily controlled.

Another object of the present invention is to provide a development roller of an electric-photographic machine having a low electric resistivity by cross-linking rubber blended with an electric conductive high-molecule-weight material, which is excellently compatible with the cross-linking rubber, instead of adding an electric conductive agent such as a conductive liquid or carbon blacks. Accordingly, because this development roller can be formed into a single layer, a manufacturing process of the development roller becomes simple. Thus, man hours and a defective rate in manufacturing the development roller are decreased, and the manufacturing process is easily controlled.

Yet another object of the present invention is to provide a development roller of an electric-photographic machine that radiates the surface of the development roller with ultraviolet light for changing unsaturated double bonds in rubber or resin into stable single bonds, volatilizing or burning adhesive constituents on the surface of the development roller, and reducing a friction force of the surface of the development roller. Therefore, there are no transfer defects caused by excessive transfer of toner, no unevenness of an image concentration caused by a toner layer poorly regulated, and no toner degradation caused by excessively rubbing against the development roller of high hardness.

Additional objects and advantages of the invention will be set forth in part in the description which follows and, in part, will be obvious from the description, or may be learned by practice of the invention.

To achieve the above and other objects, a development roller of an electric-photographic machine according to an embodiment of present invention is manufactured by a method of manufacturing the development roller. The method includes mixing a base material being either NBR rubber or HYDRIN rubber, an electric conductive high-molecule-weight material adjusting electric resistivity of the development roller, and peroxide as a cross-link agent cross-linking the base material and the electric conductive high-molecule-weight material in a three-dimensional structure, forming the development roller from a mixture of the base material, the electric conductive high-molecule-weight material, and the peroxide, and radiating the development roller with ultraviolet light to adjust a friction coefficient of a surface of the development roller.

The development roller has an electric resistivity layer of which thickness is in the range from 1 mm to 6 mm. Here, a resistance of the electric resistivity layer is in the range from 10³Ω to 10⁷106 .

A half life period of the peroxide is over 30 minutes at 100° C. and below 5 minutes at 200° C. in atmosphere. Also, an amount of the peroxide added to the base material is in the range from 0.01 wt % of the base material to 0.6 wt % thereof.

A cross-linking coagent raising an efficiency of the cross-linking is added to the cross-link agent. Here, wherein the cross-linking coagent is trimethyolpropanetriacrylate.

An apparatus irradiating the ultraviolet light is a lamp of ultraviolet light. A wavelength of the ultraviolet light is in the range from 200 nm to 400 nm.

The electric conductive high-molecule-weight material has pair double bonds in either a main chain or a branch of the electric conductive high-molecule-weight material.

The electric conductive high-molecule-weight material has a cyclic compound having a lot of electrons in either the main chain or the branch of the electric conductive high-molecule-weight material.

The electric conductive high-molecule-weight material is one in which a metallic complex compound is introduced into either polyethylene oxide or polypropylene.

The amount of the electric conductive high-molecule-weight material is less than a weight percentage of the base material.

A friction coefficient of the surface of the development roller is below 1.0.

A roughness of the surface of the development roller is in the range from Rz 1.0 to Rz 10 in a circumferential direction.

Another embodiment of the development roller of the electric-photographic machine is manufactured by another method of manufacturing the development roller. The method includes mixing rubber as the base material having double bonds in either a main chain or a side chain of the rubber and an elasticity in room temperature, and the electric conductive high-molecule-weight material to adjust an electric resistivity of the development roller, and the peroxide as a cross-link agent cross-linking the base material and the electric conductive high-molecule-weight material in the three-dimensional structure, forming the development roller from the mixture of the base material, the electric conductive high-molecule-weight material, and the peroxide, and radiating the development roller with the ultraviolet light to adjust the friction coefficient of the surface of the development roller.

The base material has fluidity of chain and polar molecules. Here, the polar molecules are either chlorine or cyanide.

The base material has the fluidity of a chain and functional group. Here, the functional group is hydroxyl.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a cross-sectional view showing a non-contact type development apparatus having a conventional development roller with inner and outer layers;

FIG. 2 is a cross-sectional view approximately showing a non-contact type development apparatus having a development roller according to an embodiment of the present invention;

FIG. 3 is a graph showing a change of a temperature of an inner portion of an ultraviolet light radiation apparatus radiating ultraviolet light for a period of time on a surface of the development roller of FIG. 2;

FIG. 4 is a graph showing a change of an electric resistivity of the development roller according to an amount of an electric conductive high molecular material added to base material of the development roller of FIG. 2;

FIG. 5 is a graph showing a change of hardness of the development roller in response to an amount of a cross-link agent added to the base material of the development roller of FIG. 2;

FIG. 6 is a schematic diagram showing a reaction mechanism of a surface of the development roller irradiated with the ultraviolet light;

FIG. 7 is a graph showing a change of a friction coefficient of the surface of the development roller according to the period of time radiated with the ultraviolet light;

FIG. 8 is a diagram showing a jig measuring the friction coefficient of FIG. 7; and

FIG. 9 is a flow chart showing a method of providing the development roller according to another embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

From now on, an embodiment of the present invention will be described in great detail by referring to the appended drawings.

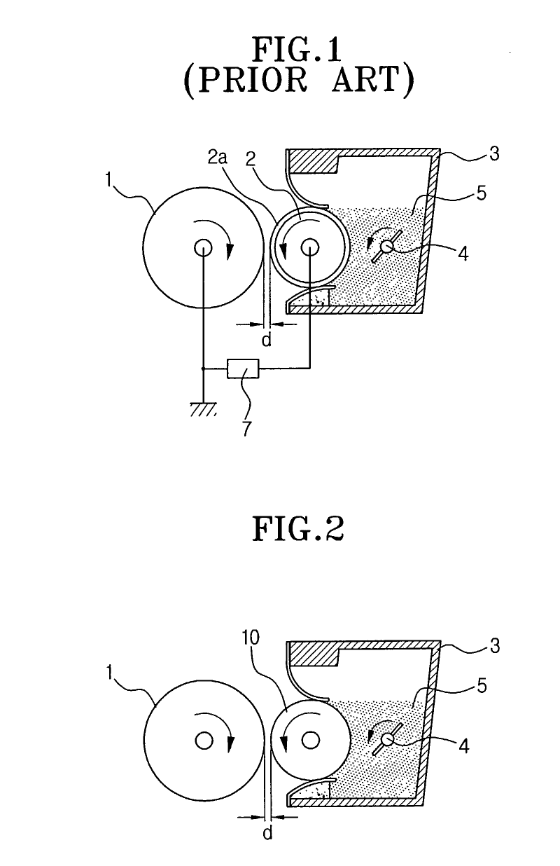

A development roller has a single layer provided coaxially on and around a shaft as illustrated FIG. 2, and includes a base material, an addition agent, and a cross-link agent. In FIG. 2, reference numerals 1, 3, 4, 5 are a photoconductive drum, a housing, an agitator, and toner, respectively.

The base material is what constitutes mainly a shape of the development roller. A rubber material that has double bonds in either a main chain or a side chain thereof and an elasticity at room temperature is used as the base material. The base material is made of the rubber, such as nitrile butadiene rubber (NBR rubber) or epichlorohydrin rubber (Hydrin rubber), which has a relatively low volume resistance and is made with a low price.

Also, another material having an excellent fluidity and made of a polar molecule, such as chlorine, or a functional group, such as cyanide or hydroxyl, can be used as the base material.

The addition agent is added to the base material to make the electric resistivity of the development roller 10a a low electric resistivity below 10⁶106 . In the present invention, an electric conductive high-molecule-weight material is used as the addition agent. This electric conductive high-molecule-weight material has a resonance structure or a conjugated structure, such as polyaniline or polypyrrole. And the electric conductive high-molecule-weight material has an excellent compatibility that is homogeneously dispersed when being mixed with the rubber material of the base material, and neither an abnormal phenomenon, such as phase separation, a loss or variation of conductivity, and a degradation even when the development roller 10 has not used for a relatively long period of time occurs.

Also, a cyclic compound having paired double bonds in a main chain of polymer or a lot of electrons, or one of metallic complex compounds, such as ZnCl2, LiClO4 and the like, is added to either polyethylene oxide or polypropylene oxide which can be used as the electric conductive high-molecule-weight material.

The cross-link agent is added in order to convert the rubber material of the base material and the electric conductive high-molecule-weight material into a three-dimensional reticular cross-linking structure. In this invention, peroxide that is employed in cross-linking of plastic is used as the cross-link agent instead of sulfurs generally used in cross-linking of the rubber material.

This peroxide might not be resolved for a long period of time at internal and external (ambient) temperature generated when the peroxide is mechanically mixed with the rubber material and the electric conductive high-molecule-weight material. And a half-life period of the peroxide might be over 30 minutes in 100° C. and below 5 minutes in 200° C. Also, after the peroxide is resolved, there is no residue or even the smallest residue. The peroxide has a characteristic that a by-product is easily removed if the by-product is produced in cross-linking of the rubber material.

For example, because when azobisisobutyronitrile (AIBN) is used as the cross-link agent, the azobisisobutyronitrile is decomposed within 6 minutes at 100° C., the azobisisobutyronitrile is decomposed at the internal temperature produced in a mixing process that the azobisisobutyronitrile is mixed with the rubber material and the electric conductive high-molecule-weight material, and so makes the rubber material and the electric conductive high-molecule-weight material to be cross-linked. Accordingly, the azobisisobutyronitrile cannot be employed in a continuous process such as an extrusion. Therefore, a material such as a dimethyldi (benzoylperoxy) hexane of which half-life period is over 1 hour should be employed as the cross-link agent. But because the cross-linking reaction takes a long period of time if the cross-link agent has an excessive half-life period or exceedingly high temperature of decomposition, use of the adequate peroxide is needed.

Cross-link agents that can be used in the development roller 10 according to the present invention are shown in TABLE 1. These cross-link agents may be used alone or in combination.

TABLE 1

| | Temperature of decomposition at selected | | | Activation |
|---|---|---|---|---|
| | half-life values (° C.) | | | energy |
| | T1/2 = 1 min. | T1/2 = 10 hrs. | T1/2 = 100 hrs | (Kcal/mole) |
| Bezoyl peroxide | 130 | 74 | 57 | 31.1 |
| Bis(t-butylperoxy)3,3,5- | 148 | 90 | 73 | 33.2 |
| trimethylcyclohexane | | | | |
| t-buty peroxybenzoate | 170 | 104 | 85 | 35.5 |
| di-cumyl peroxide | 171 | 117 | 101 | 40.6 |
| Dimethyl-2,5-di(t-butylperoxy) | 179 | 118 | 99 | 36.3 |
| hexane | | | | |
| t-butyl cumyl peroxide | 176 | 120 | 103 | 38.2 |

Also, a cross-linking coagent such as trimethyolpropanetriacrylate (TMPTA) may be employed to raise (improve) an efficiency of the cross-linking. Because a coupling reaction among decompounded alkyl groups or, a β-scission reaction, such as cutting a main chain, is restrained, and because a steric interference or an effect of resonance is minimized by the cross-linking coagent, the peroxide is efficiently operated.

By using the materials as described above, the method of manufacturing the development roller 10 according to the present invention is described as follows.

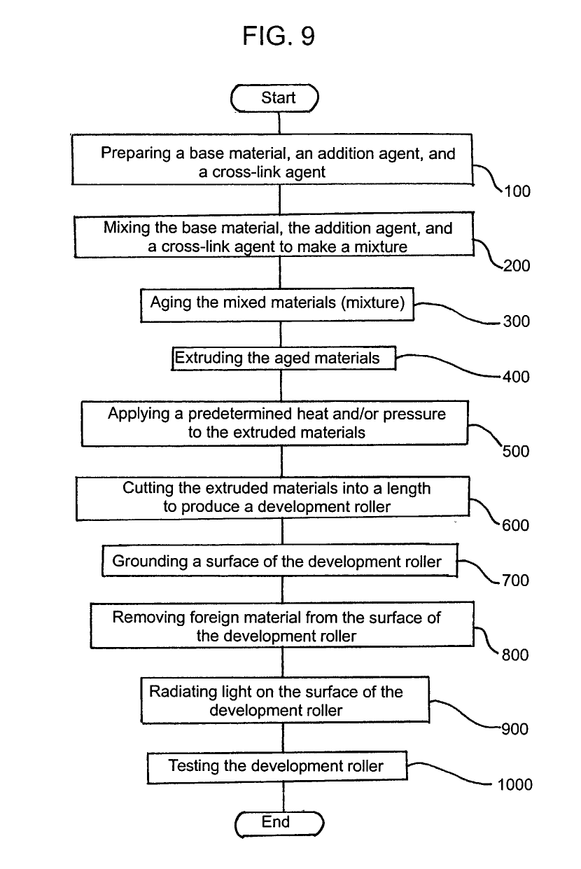

The rubber material as the base material, the electric conductive high-molecule-weight material as the addition agent, the peroxide as the cross-link agent, and so on is prepared. Respective amounts of the rubber material, the electric conductive high-molecule-weight material, the peroxide, and so on are prepared according to a predetermined mixing ratio in operation 100 of FIG. 9.

The materials as described above are uniformly mixed in a mixer, such as an open roller, in operation 200. At this time, to improve stability of shaping and abrasive quality, fillers are added to a mixture of the materials. The mixer means an apparatus that can mix physically several materials, such as a kneader, a banbury, an extruder, and the like.

In order to restore a structure array entangled in a mixing process, the mixed materials are aged for a predetermined period of time at room temperature in operation 300. The room temperature is generally in the range from 15° C. to 20° C., and the predetermined period of time is in the region from 6 hours to 24 hours.

In a next step, the aged mixed material is extruded through a single axis-extruding machine or a double axis-extruding machine in operation 400. At this time, to prevent the extruded material from getting out of (being deformed to) a shape caused by a high viscosity of the rubber material, and to minimize damage of the addition agent caused by heat, the extruding temperature is below 90° C.

Either a predetermined heat or a predetermined heat and pressure is applied to the extruded material extruded continuously through the extruding machine in operation 500. And then the added cross-link agent is decompounded so that the rubber material and the electric conductive high-molecule-weight material are formed as the three-dimensional reticular structure by cross-linking. If the extruded material has the three-dimensional reticular structure, the extruded material becomes an elastic solid. When only heat is applied, the predetermined heat is in the range from 150° C. to 180° C. When the heat and pressure are applied together, the predetermined heat is in the range from 150° C. to 180° C., and the predetermined pressure is over 4 kgf/cm².

The cross-linked extruded material is cut in a suitable length to form the development roller 10 in operation 600.

The surface of the development roller 10 is ground to adjust an outer diameter and a surface roughness of the development roller 10 in operation 700.

Foreign materials adhered to the surface of the development roller 10 during processes described above are removed in operation 800.

In the next step, the development roller 10 is exposed into radiation of ultraviolet light to lower a surface friction coefficient of the development roller 10 and to volatilize residual organic substances, etc., on the surface of the development roller 10 in operation 900. An apparatus radiating the ultraviolet light mainly uses a lamp which is able to radiate the ultraviolet light having a wavelength in the range from 200 nm to 400 nm. At this time, a predetermined period of time for irradiating the development roller 10 is decided according to a type of the lamp. In this embodiment, the ultraviolet light radiating apparatus has 6 low pressure mercury lamps each having a short wavelength region which are radiated in turn.

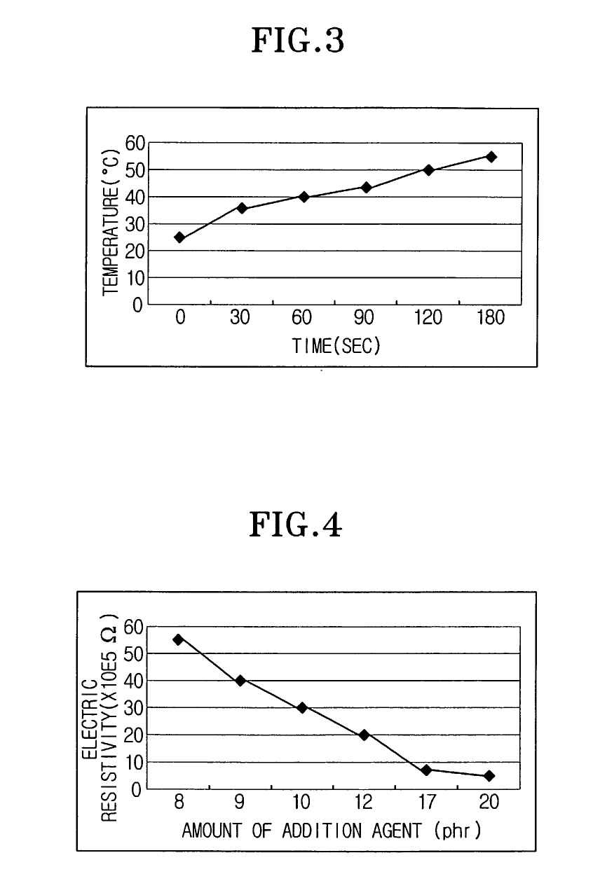

Also, during radiating the surface of the development roller 10 with the ultraviolet light, the internal temperature of a chamber of the ultraviolet light radiating apparatus must be controlled below a predetermined temperature to prevent the development roller 10 from being aged by heat such as crack or discoloration of surface thereof. Here, the predetermined temperature can be below 80° C. or below 60° C. To minimize damage caused by heat of the development roller 10, it is possible that a distance between the lamp and the development roller 10 is kept at a predetermined length, and a period of time radiating the development roller 10 is controlled. A graph showing a change of a surface temperature of the development roller 10 in the chamber of the ultraviolet light radiating apparatus according to the period of time radiating with ultraviolet light is shown in FIG. 3.

Finally, after a surface treatment described above is done, the development roller 10 is checked for appearance, electric resistivity, and dimension, and so on in operation 1000.

From now on, in the development roller 10 manufactured from the materials and through the process as described above, characteristics of the development roller 10 according to the present invention caused by the addition agent, the cross-link agent, and the ultraviolet light surface treatment are described as follows.

Because the addition agent used in the present invention is the electric conductive high-molecule-weight material having a high electron mobility, the electric resistivity of the development roller can be lowered substantially. This electric conductive high-molecule-weight material means a high-molecule-weight material having a resonance structure, a cyclic compound with paired double bonds in a main chain of polymer, a cyclic compound with a lot of electrons, a metallic complex compound, or a salt that becomes a strong electrolyte because it is ionized when being dissociated in water. If the addition agent which has no resonance structure or paired double bonds in the main chain of polymer, or has a low fluidity of a molecular chain is used, the mobility of the electrons is pretty low. Therefore, the electric resistivity of the development roller 10 becomes high.

Because the addition agent used in the present invention can show the characteristics even if a small amount of the addition agent is added to the base material, the development roller 10 having desirable electric resistivity can be made without affecting hardness and workability of the development roller 10. A change of electric resistivity of the development roller 10 according to the amount of the addition agent added to the based material is shown in FIG. 4. Referring to FIG. 4, in spite of the fact that the small amount of the addition agent is added, the development roller 10 has the lower electric resistivity than a typical nitrile rubber material. And when the addition agent is added over 17 phr, the development roller has the electric resistivity below 10⁵Ω as if a conductive material.

The peroxide frequently used for cross-linking plastic as the cross-link agent can minimize a variation of measurements as compared with the sulfur cross-linking agent.

Also, in a case of the sulfur cross-linking agent, because when a ring open reaction occurs due to heat in sulfur having an octagon structure, and the rubber is formed of the cross-linking reticular structure that are coupling structures of —C—Sx—C—(x32 8) between chains of a high molecular weight, the rubber is remained elastic. But, in a case of the peroxide cross-linking because the coupling between the chains of the high molecular weight becomes —C—C— coupling without a buffering effect, the rubber is more rigid and stronger than the rubber coupled by the sulfur. Therefore the rubber cross-linked by the peroxide improves a compression force, a tear strength, a heat resistance, and a abrasion resistance. Besides, because the rubber as described above is not sensitive of a scotch phenomenon that is a kind of pre-cross-linking when occurring in an extruding process, workability of the rubber is excellent.

Also, because the development roller 10 cross-linked by the peroxide has a good adhesive force between the chains and the low fluidity, it has excellent machinability. Therefore, an abrasive quality of the development roller 10 is improved so that an expected surface roughness of the development roller 10 can be accomplished by a grinding process of grinding the surface of the development roller 10.

Also, because a degree of the cross-linking can be easily controlled by controlling the content of the peroxide added in the base material, man hours of the peroxide cross-linking can be reduced compared with the sulfur cross-linking.

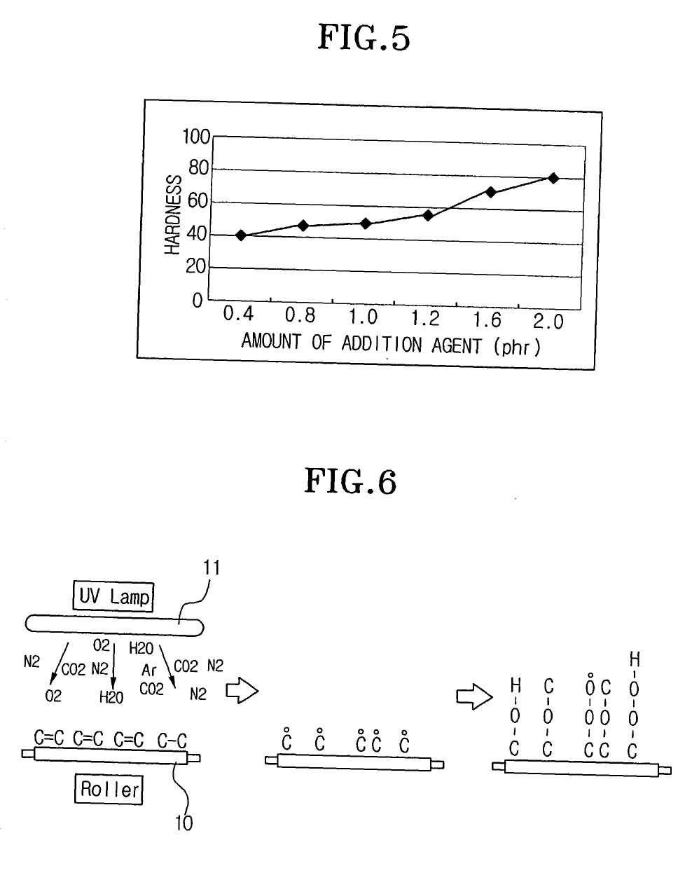

But, because if the peroxide is excessively added, hardness of the development roller 10 tends to increase excessively, the amount of the added peroxide should be in the range from 0.1 phr to 3.0 phr. When the amount of the added peroxide is below 0.1 phr, the cross-linking reaction does not occur sufficiently, so that the surface of the development roller 10 has adhesivity. Therefore, the surface of the development roller 10 is stuck to the toner or the photoconductive drum, and so an abnormal image is printed. When the amount of the added peroxide is over 3.0 phr, the hardness of the development roller 10 is excessively increased, so that the toner gets damaged. Thus, because a nip between the regulating member and the development roller 10 is unstable, there occurs a problem that a long-run image becomes poor. Accordingly the peroxide is added in the range from 0.5 phr to 1.5 phr. A graph showing a change of the hardness of a development roller 10 according to the amount of the cross-link agent added to the base material of the development roller is shown in FIG. 5.

The surface treatment of the development roller by irradiating the ultraviolet light is described as follows.

Energy of the ultraviolet light having a wavelength in the range from 200 nm to 400 nm is higher than in the range from 400 nm to 700 nm. When the surface of the development roller is continuously radiated with the ultraviolet light having the wavelength in the range from 200 nm to 400 nm, the double bonds having enough electrons of the surface of the development roller 10 are excited. When the excited surface of the development roller 10 is continuously radiated with the ultraviolet light, the double bonds are decomposed, and so the decomposed double bonds are coupled with surrounding different molecules. Especially, because the energy of the ultraviolet light having the wavelength of 200 nm is higher than the bond energy of oxygen molecules or of water vapor, the oxygen bonds of the oxygen molecules or of the water vapor are cut by the energy of this ultraviolet light. Therefore because the oxygen molecules or the water vapor with the cut oxygen bonds is coupled with the decomposed double bonds, the surface of the development roller becomes hydrophilic. A mechanism of a hydrophilic reaction is roughly shown in FIG. 6.

Referring to FIG. 6, the hydrophilic reaction is described in detail as follows. When the surface of the development roller 10 is radiated with the ultraviolet light having the high energy from a mercury lamp, the hydrocarbon bonds, especially double bonds having enough electrons, in the surface of the development roller are excited and decomposed and become radical. The radical bonds are marked with “°” in FIG. 6. At this time, because molecular bonds of the materials, such as water, nitrogen, and oxygen, and so on, which surround the development roller 10, are decomposed together, the decomposed instable materials are recombined with the radical bonds in the surface of the development roller 10, and so a hydrophilic group such as a hydroxyl group is brought to the surface of the development roller. Also, by the hydrophilic reaction as described above, because the double bonds existing in the surface of the development roller 10 are substituted for more stable single bonds, the development roller 10 has little secular change and excellent durability. In other words, when a cross-linked development roller 10 having the rubber and electric conductive high-molecule-weight material is irradiated with the ultraviolet light, an unsaturated structure that exists in the surface of the development roller 10 is reacted with oxygen, etc., in atmosphere by the high energy of the ultraviolet light, and is changed to a saturated structure having an Ox structure. Accordingly, the surface of the development roller 10 becomes hydrophilic. Also, because foreign materials, such as residual, or oligomer, remaining on the surface of the development roller 10 is decomposed or volatilized by radiant heat with the high energy, the side effect between the development roller 10 and the toner or photoconductive drum is minimized.

Also, the surface treatment by irradiating the ultraviolet light has attendant effects as follows. First, the surface of the development roller 10 is cleaned because organic matter existing on the surface of the development roller 10 is removed by radiating of the ultraviolet light. Second, the material having a complicated shape or a three-dimensional form can be treated uniformly. Third, because a local surface treatment can be done on the development roller, a change of the whole characteristics of the development roller 10 can be minimized. Fourth, the surface treatment can be done in room temperature.

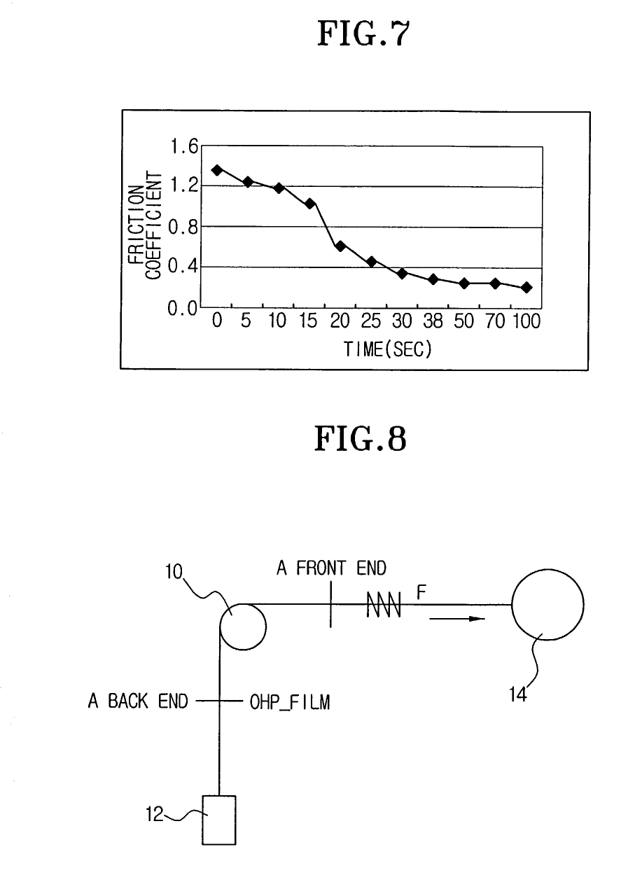

Especially, because the surface of the development roller 10 is hardened by heat generated by the ultraviolet light, there is an effect that a friction coefficient of the surface of the development roller 10 is decreased. At this time, a relation between a period of time irradiating with the ultraviolet light and a friction coefficient of the surface of the development roller 10 is changed according to a kind of a lamp radiating the ultraviolet light. In this embodiment of the present invention, there is used an apparatus that has 6 low pressure mercury lamps each having a short wavelength region which are turned on and off to radiate in turn. In FIG. 7, a graph showing a change of the friction coefficient of the surface of the development roller 10 according to a period of time that the ultraviolet light is radiated from one lamp is shown.

Referring to FIG. 7, when a low pressure mercury lamp is used, a period of time that the development roller 10 is radiated with one lamp is in the range from 5 seconds to 70 seconds. When the radiated period of time is below 10 seconds, there is almost no change of the friction coefficient of the surface of the development roller 10. Therefore the friction force of the surface thereof is not reduced, and so toner is degraded, receives the physical stress, and is excessively transferred. Also, when the irradiated period of time is over 70 seconds, the development roller 10 is excessively heated. Therefore, the surface thereof is degraded or discolored, or cracked on, and so a capacity of transferring the toner of the development roller 10 is decreased. Accordingly, to maintain the friction coefficient of the surface of the development roller 10 below at least 1.0 and for being not overheated, the radiated period of time is set in the range from 15 seconds to 50 seconds.

At this time, the friction coefficient in FIG. 7 is measured by using a jig measuring the friction coefficient shown in FIG. 8. In the jig, a weight 12 weighs 33 gf, and a motor rotating the development roller 10 runs at 30 rpm. An OHP film that has a width of 15 mm is used to measure the friction coefficient of the development roller 10. To measure the friction coefficient, a front side of the OHP film is used, and a length of the OHP film is not limited. Also, the front end of the OHP film is engaged with a moving end of a spring gage 14. The OHP film and the spring gage 14 is set to be horizontal with respect to a ground, and the front side of the OHP film is contacted with the surface of the development roller 10. Then the weight 12 joined to a back end of the OHP film is arranged to be perpendicular to the spring gage 14. At this time, the spring gage 14 is adjusted that a first notch mark of the spring gage 14 corresponds to a force applied by the OHP film and the weight 12. Therefore, when the development roller 10 is rotated, the OHP film is moved by the friction force between the OHP film and the surface of the development roller 10, and so the moving end of the spring gage 14 is moved. Especially, before the friction coefficient of the development roller 10 is measured, the development roller 10 is left alone at 23° C. and 55% humidity for over 6 hours.

In the jig as described above, the friction coefficient of the development roller 10 is calculated by the following formula:

$$μ = \frac{2}{π} \cdot ln ( \frac{F}{W} ) \qquad < Formula 1 >$$

where μ is the friction coefficient of the surface of the development roller 10, F is the value measured by the spring gage 14, and W is weight of the weight 12.

According to the present invention as described above, the development roller 10 has the characteristics of a low electric resistivity even with a single layer structure. Especially, because the development roller 10 is made of a low cost rubber material instead of a high cost urethane rubber material, the development roller 10 is profitable in terms of manufacturing cost.

Also, because the electric conductive high-molecule-weight material having excellent compatibility with the rubber material and having no abnormal phenomenon such as phase separation is used as the addition agent, the development roller 10 has the low electric resistivity and does not show any abnormal phenomenon, such as a surface migration of the addition agent, a secular change of hardness, and high hardness.

Furthermore, because the base material and the electric conductive high-molecule-weight material are cross-linked together by the peroxide cross-linking, a period of time of a cross-linking process is reduced. And, the abnormal phenomenon such as the surface migration of the cross-link agent is minimized. Also, because the development roller cross-linked by the peroxide has excellent abrasive quality, the surface roughness of the development roller is easily adjusted.

Also, because the development roller 10 is irradiated in atmosphere with the ultraviolet light of high energy, the friction force of the surface of the development roller 10 is reduced. Because the surface treatment of the ultraviolet light as described above can be done regardless of the shape of the development roller 10 and against a partial region of the development roller 10, the change of the physical properties of the development roller 10 is minimized. And because by radiating the ultraviolet light, the adhesive constituent on the surface of the development roller 10 is volatilized or burned, and the friction force of the surface of the development roller 10 is decreased, the abnormal phenomenon, such as a transfer defect caused by excessively transferring toner, unevenness of image concentration caused by toner layer unstably regulated, and toner degradation caused by excessively rubbing against the development roller 10 of high hardness, and so on, does not occur.

Consequently, because the development roller 10 according to the present invention has the single layer structure, it may be provided with the development roller 10 that the manufacturing process thereof is simple, the manufacturing cost thereof is low, and an adhesive defect between layers thereof does not occur.

Also, because the development roller 10 according to the present invention is made of typical semi-conductive rubber as the base material, it may be provided with the development roller 10 that the manufacturing cost thereof is lower than the urethane rubber, and the migration or solidification of the toner occurring in silicone rubber does not occur.

Also, because the development roller has the low electric resistivity by adding the electric conductive high-molecule-weight material and has the surface treatment by radiating the ultraviolet light, it may be provided with the development roller that the phenomenon, such as the surface migration of the addition agent, a secular change of hardness, and high hardness, does not occur.

In the drawings and specification, there have been disclosed a typical preferred embodiment of the invention and, although specific terms are employed, they are used in a generic and descriptive sense only and not for purpose of limitation, the scope of the invention being set forth in the following claims.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of producing a development roller of an electric-photographic machine, the method comprising:
mixing either NBR rubber or HYDRIN rubber as a base material, and an electric conductive high-molecule-weight material as an addition agent to adjust an electric resistivity of the development roller, and peroxide as a cross-link agent cross-linking the base material and the electric conductive high-molecule-weight material in a three-dimensional reticular structure;
forming the development roller from a mixture of the base material, the electric conductive high-molecule-weight material, and the peroxide; and
radiating the development roller with ultraviolet light to adjust a friction coefficient of a surface of the development roller.

2. The method of claim 1, wherein the forming of the development roller comprises:
forming an electric resistivity layer having a thickness in the range from 1 mm to 6 mm.

3. The method of claim 2, wherein the forming of the development roller comprises:
forming the electric resistivity layer having a resistance between 10³Ω and 10⁷Ω inclusive.

4. The method of claim 1, wherein the mixing of the base material, the addition agent, and the cross-link agent comprises:
mixing the peroxide with the base material and the cross-link agent during a half life period of the peroxide which is resolved over 30 minutes at 100° C. and below 5 minutes at 200° C. in atmosphere.

5. The method of claim 4, wherein the mixing of the base material, the addition agent, and the cross-link agent comprises:
adding an amount of the peroxide to the base material, the amount of the peroxide being in the range between 0.01 wt % of the base material and 6.0 wt % thereof inclusive.

6. The method of claim 1, wherein the mixing of the base material, the addition agent, and the cross-link agent comprises:
adding a cross-linking coagent to the cross-link agent to raise an efficiency of the cross-linking of the base material and the addition agent.

7. The method of claim 6, wherein the mixing of the base material, the addition agent, and the cross-link agent comprises:
adding trimethyolpropanetriacrylate to the mixture as the cross-linking coagent.

8. The method of claim 1, wherein the radiating of the development roller comprises:
radiating ultraviolet light by using a lamp emitting the ultraviolet light.

9. The method of claim 1, wherein the radiating of the development roller comprises:
radiating the light having a wavelength in the range between 200 nm and 400 nm inclusive.

10. The method of claim 1, wherein the mixing of the base material, the addition agent, and the cross-link agent comprises:
adding the electric conductive high-molecule-weight material having paired double bonds in either a main chain or a branch of the electric conductive high-molecule-weight material.

11. The method of claim 1, wherein the mixing of the base material, the addition agent, and the cross-link agent comprises:
adding the electric conductive high-molecule-weight material having a cyclic compound having electrons in either a main chain or a branch of the electric conductive high-molecule-weight material.

12. The method of claim 1, wherein the mixing of the base material, the addition agent, and the cross-link agent comprises:
adding the electric conductive high-molecule-weight material which is a metallic complex compound, to polyolefin.

13. The method of claim 1, wherein the mixing of the base material, the addition agent, and the cross-link agent comprises:
adding an amount of the electric conductive high-molecule-weight material which is less than a weight percentage of the base material.

14. The method of claim 1, wherein the forming of the development roller comprises:
forming a surface of the development roller having a friction coefficient of below 1.0.

15. The method of claim 1, wherein the forming of the development roller comprises:
forming a surface of the development having a roughness in the range between Rz 1.0 and Rz 10 in a circumferential direction inclusive.

16. A method of producing a development roller of an electric-photographic machine, the method comprising:
mixing a rubber material as a base material having double bonds in either a main chain or a side chain of the rubber material and an elasticity in room temperature, an electric conductive high-molecule-weight material as an addition agent to adjust an electric resistivity of the development roller, and peroxide as a cross-link agent cross-linking the base material and the electric conductive high-molecule-weight material in a three-dimensional reticular structure;
forming the development roller from the mixture of the base material, the electric conductive high-molecule-weight material, and the peroxide; and
radiating the development roller with ultraviolet light to adjust a friction coefficient of a surface of the development roller.

17. The method of claim 16, wherein the mixing of the base material, the addition agent, and the cross-link agent comprises:
adding the base material having fluidity of the chain and polar molecules.

18. The method of claim 17, wherein the polar molecules are chlorine.

19. The method of claim 17, wherein the polar molecules are cyanide.

20. The method of claim 16, wherein the mixing of the base material, the addition agent, and the cross-link agent comprises:
adding the base material having a fluidity of the chain and a functional group.

21. The method of claim 20, wherein the functional group is hydroxyl.

22. The method of claim 1, wherein the development roller has the friction coefficient maintained below 0.8 by using an radiating apparatus emitting light having a wavelength ranging from about 200 nm to about 400 nm.

23. The method of claim 22, wherein the electric resistivity of the development roller ranges from about 10³106 to about 10⁷ω, and a roughness of the surface of the development roller ranges from about Rz 1.0 to about Rz 10 in a circumferential direction.

24. A method of making a development roller of an electric-photographic machine, the method comprising:
mixing a base material, an addition agent, and a cross-link agent cross-linking the base material and the addition agent in a three-dimensional reticular structure;
aging the mixed material;
applying a predetermined heat and/or pressure to the mixed material to produce the development roller;
grinding a surface of the development roller;
removing foreign material from the surface of the development roller; and
radiating light on the surface of the development roller.

25. The method of claim 24, further comprising:
extruding the aged material to produce an extruded material.

26. The method of claim 25, further comprising:
cutting the extruded material into a length to produce the development roller.

27. The method of claim 24, wherein the mixing of the base material, the addition agent, and the cross-link agent comprises:
mixing one of NBR rubber and HYDRIN rubber as the base material, an electric conductive high-molecule-weight material as the addition agent to adjust an electric resistance of the development roller, and peroxide as the cross-link agent.

28. The method of claim 24, wherein the radiating of the development roller comprises:
radiating the development roller with ultraviolet light to adjust a friction coefficient of a surface of the development roller.

29. A development roller of an electric-photographic machine comprising:
a single layer made of a mixture of a base material, an addition agent, and cross-link agent, the base material made of one of NBR rubber and HYDRIN rubber, the electric conductive high-molecule-weight material adjusting an electric resistivity of the development roller, and peroxide cross-linking the base material and the electric conductive high-molecule-weight material in a three-dimensional reticular structure.

30. The development roller of claim 29, wherein the electric conductive high-molecule-weight material is polyaniline or polypyrrole having a resonance structure or a conjugated structure.

31. The development roller of claim 29, wherein the electric conductive high-molecule-weight material is homogeneously dispersed when being mixed with the base material rubber to prevent abnormal phenomenon of phase separation, loss or variation of a conductivity, and degradation of the development roller when the development roller is not used for a predetermined period of time.

32. The development roller of claim 29, wherein the electric conductive high-molecule-weight material is made of one of polyethylene oxide and polypropylene oxide and one of a cyclic compound having paired double bonds in a main chain of polymer or electrons and a metallic complex compound.

33. The development roller of claim 32, wherein the metallic complex compound is one of ZnCl₂ or LiClO₄.

34. The development roller of claim 29, wherein the cross-link agent is one of azobisisobutyronitrile (AIBN) and dimethyldi (benzoylperoxy) hexane.

35. The development roller of claim 29, wherein the cross-link agent is made of at least one of Bezoyl peroxide, Bis(t-butylperoxy)3,3,5-trimethylcyclohexane, t-buty peroxybenzoate, di-cumyl peroxide, Dimethyl-2,5-di(t-butylperoxy) hexane, and t-butyl cumyl peroxide.

36. The development roller of claim 29, wherein the mixture further comprises:
a cross-linking coagent added to the cross-link agent to raise an efficient of the cross-linking of the base material and the addition agent.

37. The development roller of claim 36, wherein the cross-linking coagent is trimethyolpropanetriacrylate (TMPTA).

38. The development roller of claim 36, wherein the cross-linking coagent prevents a coupling reaction among decompounded alkyl groups of the mixture or a β-scission reaction cutting the main chain of the addition agent.

39. The development roller of claim 36, wherein the cross-linking coagent minimizes a steric interference or a resonance effect of the mixture to efficiently mix the peroxide with the base material, the addition material, and the cross-link agent.
